(19) United States
(12) Patent Application Publication
(10) Pub. No.: US 2009/0321094 A1
(43) Pub. Date: Dec. 31, 2009

(54) Fire suppression delivery system

(76) Inventor: Michael Steven Thomas, Bellerose, NY (US)

Correspondence Address: Michael S. Thomas;Thomas Technologies Research and Development, Inc., 254-03 86th Avenue, Suite 2, Bellerose, NY, 11426-2404, US

(21) Appl. No.: 11/436,681

(22) Filed: May 18, 2006

Related U.S. Application Data
(63) Continuation-in-part of application No. 11/349,785, filed on Feb. 7, 2006.
Application No. 11/349,785 is a continuation-in-part of application No. 10/902,598, filed on Jul. 29, 2004.
(60) Provisional application No. 60/491,816, filed on Jul. 31, 2003.

(51) Int. Cl. A62C 31/22

(52) U.S. Cl. 169/70

(57) ABSTRACT

Within the Fire Suppression Delivery System the fire extinguishment encasement is modified to produce a hybrid smart fire extinguishment encasement incorporating drone-like functions to effect fire suppression. This will allow for standard smart fire extinguishment encasement deployment or an extended range, propulsion assisted smart fire extinguishment encasement with the capacity to navigate within a structure and hover within same, in anticipation of access to an obstructed fire zone, discharge while hovering, surface attached or on-the-fly.

This application is a continuation-in-part application of U.S. Ser. No. 11/349,785, filed Feb. 7, 2006, which is a continuation-in-part application of U.S. Ser. No. 10/902,598 (herein, referred to as Publication No. 20050139363) filed Jul. 29, 2004, which claims benefit of Provisional Patent Application No. 60/491,816. The content of which is incorporated in its entirety into this application by reference.

All literature cited herein are incorporated in their entirety by reference into this application.

### BACKGROUND OF THE INVENTION

This is a Fire Suppression Delivery System for the delivery of current, Next Generation, and future developments in the area of materials to extinguish, suppress or retard fires in, but not limited to high rise, commercial and industrial buildings; tunnel structures; offshore structures and marine platforms; marine vessels; and environmental areas.

The application of the Fire Suppression Delivery System is the ability to place fire extinguishment material directly within or effectively proximate to a fire, beyond the reach of conventional fire extinguishment and firefighting methods. The Smart Fire Suppression Delivery System provides the means for an authorized operator to scan a structure where a fire is known or suspected; to produce a two-dimensional and/or a three-dimensional structural and thermal layout; to program a standard or smart fire extinguishment encasement for projection and delivery therein to the target fire area; and, to extinguish or retard the fire. This includes the Fire Suppression Delivery System Aerial Fire Suppression Drone, and particularly its vertical flight modification adapted for operations within a structural fire as well.

Evolved fires rarely exist in neat, contained areas awaiting the attention of firefighters. Thus, it is not uncommon that while a primary fire exists within one area of a structure, others fires can exist behind closed doors, deep set areas, sub-floors, passageways, etc. Whereas a primary fire or primary area fire may be accessible to firefighters, fires existing at the same time within these secondary areas or substructures often are not (as readily accessible): thereby requiring firefighters to venture further into a burning structure to attack a substructure fire or rely more upon the surround and drown and other techniques. Here, a concern does arise where a structural fire that has not breached the exterior walls to permit access to firefighters, but exists beyond the sustainable trajectory of a standard launch, smart or sentinel Fire Suppression Delivery System fire extinguishment encasement: even when projected by an authorized operator positioned within a fire zone to a deeper or different fire target region. This concern is furthered where a secondary fire exists within a room (i.e., a fire within an enclosed area), interior or substructure that has not breached the containment walls and may not be accessible to firefighters until the fire or firefighters breach same: yet, such fires demand attention. This concern may be exacerbated where fire extinguishment systems within the sub area have failed or are nonexistent: the fire within will continue, creating a greater conflagration, and pose a risk to property and firefighters fighting the blaze within the primary structure.

To overcome this concern, where the fire target area is beyond the targeting reach of a fire extinguishment encasement or the navigation and propulsion of the fire extinguishment encasement, smart fire extinguishment encasement and other Fire Suppression Delivery System encasement-type, an adaptation of the fire extinguishment encasement and smart fire extinguishment encasement is proposed to create a hybrid—a fire extinguishment encasement with drone-like features: with a lower trajectory profile, increased structural navigation capabilities, the ability to reach areas deeper than currently possible; and, the capacity to hover in wait for access to the secondary target area when a breach of sufficient size is created by the fire or firefighters, to hover and discharge or discharge its fire extinguishment load on-the-fly. This is a Fire Suppression Delivery System Hybrid Smart Fire Extinguishment Encasement that can function as a smart fire extinguishment encasement with and without activation of its drone-like features.

In the co-pending applications, Ser. No. 20050139363, filed Jul. 29, 2004, and Ser. No. 11/349,785 filed Feb. 7, 2006, entitled the Fire Suppression Delivery System, such disclosed the encasement of fire extinguishment materials for delivery to a fire zone that could be discharged to a fire environment through several means:

including impact or controlled degradation of the encasement. A smart fire extinguishment encasement was proposed that would allow a projected encasement to navigate a structure or environment, target a general or specific thermal target or zone therein, the ability to attack a fire horizontally, vertically and with greater coverage than standard and other firefighter methods, providing greater reach while at the same time affording a safer distance from the fire in which firefighters could work. The smart system included electronic, wireless programming of an encasement with linkage to software that controlled its navigation, trajectory, search, discharge and other parameters, including the deployment of stabilizing fins to correct its pitch and yaw, stabilize its spin and assist to navigate intended target fire zone.

Thomas, Ser. No. 11/349,785, a continuation-in-part to 20050139363, included the use of a projectile airbrake system, enhanced software security, a method to deliver, mix and discharge foam firefighting material to a fire, while incorporating recent developments to increase the foam creation ratio and effective foam projection. (The injection of compressed air or gas into a foam fire fighting material mixture, and improvements in foam ejection nozzle designs have been explored by a number of inventors, including U.S. Pat. Nos. 6,109,359 [6,276,459, 6,328,225, 6,089,324]). U.S. Pat. Nos. 6,892,644 and 6,138,547 supports the feasibility of a wireless electronic communication method to program the Smart Fire Extinguishment Encasement and the Hybrid Smart Fire Extinguishment Encasement.

The application of canards and stabilizing fins to steer, turn, control the spin and rotation of a projectile and aircraft are well documented by U.S. Pat. Nos. 6,981,672, 6,402,087 and 6,307,514. Advancements in the design of

Micro Electronic Mechanical Systems, Inertial Measurement Units and other sensors (U.S. Pat. Nos. 6,975,246, 6,723,975 and 6,724,341) demonstrate the ability to pack more control devices into a smaller area or a chip (U.S. Pat. No. 6,723,975), so as to operate the Hybrid Smart Fire Extinguishment Encasement without sacrificing weight, size, and at ever decreasing costs.

The ongoing development of unmanned aerial vehicles (“UAVs”) and micro-UAVs provides a continued growth of advancements that are applicable to development of the Hybrid Smart Fire Extinguishment Encasement: giving firefighters the ability to use the Hybrid Smart Fire Extinguishment Encasement, with or without activation of its propulsion means. Where the propulsion means is activated it will extend the range, search and fire combat capabilities of the Smart Fire Extinguishment Encasement: for deeper projection within a structure or fire environment, and with greater fire combat power.

As discussed at Fire Suppression Delivery System, Ser. No. 11/349,785, a problem exists with using a VTOL wing configuration for fire zone combat, even in the Hybrid Smart Fire Extinguishment Encasement. Unless shrouded from airborne projectiles common to a fire environment or the projection of surface areas that could impact the turbine, the ducted rotor design (U.S. Pat. No. 6,976,653) is limited as a propulsion method for the Hybrid Smart Fire Extinguishment Encasement. The use of or sole use of an air-breathing propulsion means raises a concern when applied to a fire environment, where smoke, particulate matter, reduced oxygen levels, etc, can compromise operations. The use of high impact filters may overcome part of the latter concern, while also increasing weight, costs and reducing fire extinguishment material containment space: though not addressing the matter of reduced oxygen levels. U.S. Pat. No. 6,918,244 discusses the use of “VTOL propulsion systems that develop a forward flow of air through the air intake duct(s), by the methods of an internal duct system, reversing the rotation of the fan, or a variable pitch (thrust reversing) fan,” whereas U.S. Pat. No. 6,789,764 proposes the use of a dual-flight mode tandem wing, U.S. Pat. No. 6,981,844 utilizes “Cyclic actuation system for a controllable pitch propeller and a method of providing aircraft control therewith,” the Hybrid Smart Fire Extinguishment Encasement requires a compact propulsion means capable of sustained low-speed horizontal and vertical flight control, hovering, and without requiring large energy and fuel needs. However, it should be noted that while the propulsion of the Hybrid Smart Fire Extinguishment Encasement is not limited to an internal combustion engine, it does require a means that will generate lift, forward propulsion and hovering that may include the use of battery/electrical, thermal harnessing, compressed gas, fuel cell systems. The history and use of the Traffic Alert and Collision

Avoidance System is well known, since its introduction subsequent to the collision of two aircraft over the Grand Canyon in 1956. Recent developments (TCAS II, TCAS III and others) have increased the situation awareness capabilities of pilots, air traffic controllers and aircraft to determine the potential for collision with other aircrafts, ground, vertical structures and obstacles. However, the approach taken by many of the improved systems is met with several limitations (aside from size and cost) when applied to Hybrid Smart Fire Extinguishment Encasement requirements. The Hybrid Smart Fire Extinguishment Encasement is required to navigate within a 3-dimensional structure, requiring situational awareness of its position to walls, ceiling, floor, obstacles, other encasements, persons in close proximity or approximate to its trajectory, doors and other concerns, in a far more restrictive atmosphere than commuter or general aviation, commercial and military aircraft and UAVs, where debris, projectiles common to a fire environment are not so prevalent elsewhere, while maneuvering about obstacles of a smaller scale and in closer operating proximity to the Hybrid, its forward, lateral, vertical and rear flight path, the position of other Hybrids/encasements in close proximity, while also tracking its fire target: yet maintaining its horizontal or vertical flight mode, hovering or attached to a surface while not in flight. GPS linkage to update the position of the Hybrid Smart Fire Extinguishment Encasement and other encasements require the ability to transmit through concrete and metal surfaces, and signal void areas of a structure. Therefore, structural fires, underground structures and underwater structure fires requiring the use of a GPS linked collision and avoidance, would be compromised and rendered ineffective.

Where U.S. Pat. No. 6,885,334 compares terrain elevation changes, U.S. Pat. No. 5,781,146 views vertical obstructions in the path of an aircraft. The Hybrid Smart Fire Extinguishment Encasement must be capable of performing such adjustments on-board, in a self-contained intuitive aircraft system, with 720° situation awareness capability. U.S. Pat. No. 6,975,246 explores collision avoidance using limited range gated video, noting “[a] vehicle often requires knowledge of its environment. This may be accomplished by integrating information derived from multiple onboard navigation sensors, such as a GPS (Global Positioning System) receiver, an IMU (Inertial Measurement Unit), an altimeter, etc. Using such sensors, the vehicle may obtain its own position, velocity and acceleration information. Information of obstacles in the path of the vehicle may also be obtained using onboard target tracking sensors to derive position and bearing information of targets proximate to the vehicle. By optimally integrating navigation sensors and target tracking sensors, guidance laws may be used to generate a desired trajectory for the vehicle.” A concern here arises with using range gated video collision avoidance in a structural fire situation, where it is limited to using a camera: optics or a laser system alone may be insufficient, and where intensifying the light in a cave is desirable, the impact of going from a dark or smoke filled environment to one of intense light caused by a fire, explosion or electrical system was not discussed. Therefore, a plurality of radar or sensor systems may be required to compensate for situations that otherwise may blind a different system.

The use of a distributed laser obstacle awareness system described in U.S. Pat. No. 6,665,063 in theory may be applicable here, where the system is adapted to splitting a beam or detection source to provide situational awareness around the Hybrid Smart Fire Extinguishment Encasement, as opposed to the proposed use of a plurality of obstacle detection sensors.

U.S. Pat. No. 6,727,841, discusses the use of “[ . . . ] a bistatic/multistatic radar system concept . . . for purposes of interrogating difficult and obscured targets via the application of low-altitude “smart” or “robotic-type” unmanned air vehicle (UAV) platforms. This is a system that [ . . . ] implements self-adaptive positional adjustments on sensed properties of the propagation channel (i.e. discontinuities),” to which the theory of such can a feature of the Hybrid Smart Fire Extinguishment Encasement as well. However, where U.S. Pat. No. 6,727,841 uses “transmitting an electromagnetic signal from a high altitude unmanned air vehicle to an urban environment including between buildings; receiving by a low altitude unmanned air vehicle a plurality of electromagnetic rays from said electromagnetic signal from said transmitting step, said electromagnetic signal diffracting and reflecting off buildings in said urban environment, an electric field at said low altitude unmanned air vehicle defined as ##EQU1##,” the use of ##EQU1## by the Hybrid Smart Fire Extinguishment Encasement may not be practical: the Hybrid Smart Fire Extinguishment Encasement is required not only to interrogate a structural area but to maneuver within and through same, target and acquire a fire zone for extinguishment purposes. The effectiveness of transmitting an electromagnetic signal from a high altitude unmanned air vehicle, again may not be practical for use here. Additional concerns arise here that may limit adaptation of this system for deployment with the Hybrid Smart Fire Extinguishment Encasement: effective transmission of electromagnetic signals through the structure and costs. On one hand the Hybrid Smart Fire Extinguishment Encasement's electronic components must be shielded from or designed to withstand the potential adverse impact of electromagnetic interference generated by other devices and the fire extinguishment encasement itself, yet able to accept electromagnetic signals broadcast by a higher altitude UAV, if U.S. Pat. No. 6,727,841 is adapted for use here.

The use of GPS to assist in collision avoidance of a Hybrid Smart Fire Extinguishment Encasement may not be viable at this time, for several reasons: de minimus, the inability of a signal to effectively penetrate a concrete and metal structure, constant change within a fire environment and whether such has the ability to detect debris and projectiles within the fire environment before it can damage an encasement. Furthermore, whereas U.S. Pat. No. 6,727,841 utilizes a GPS augmented elevation map, that allows an aircraft collision avoidance system to compare its position to ground, vertical obstructions and other aircraft, pre-mapping each floor of each structure may be prohibitive until 2-Dimensional and 3-Dimensional blueprint becomes a standard, firefighters have ready and onsite access to the database containing same, and the Fire Suppression Delivery System's software system is conformed to utilize such data so as to permit the Hybrid Smart Fire Extinguishment Encasement to compare the structural layout to obstacles found therein. Therefore, the Hybrid Smart Fire Extinguishment Encasement will have to rely upon a collision and avoidance system that can function without GPS assistance when combating fire from within the interior of a structure.

Adapting such principles as U.S. Pat. No. 6,747,576 which provides a real-time detection of obstacles for low-flying vehicles using high-pass filters to search for the occurrence of discontinuities in its scan field, may be viable. This is a front end imaging sensor that provides information concerning position and altitude generated in 3-Dimensional scene vectors, which is then inputted to an evaluation module. As well, U.S. Pat. No. 6,466,155 provides a method and apparatus for detecting a moving object through a barrier; U.S. Pat. No. 6,100,839 provides modification of impulse radar for ground penetration purposes to provide 3-Dimensional target images; and, adaptation of ground penetrating radar, through-wall vision technology, ultra-wide band and micro impulse radar systems (U.S. Pat. Nos. 6,864,826, 5,774,091), microwave sensors (U.S. Pat. No. 7,026,931), ultra-wide band radar (U.S. Pat. No. 5,805,110) and other but similar systems will permit structural and fire scanning by the Hybrid Smart Fire Extinguishment Encasement. The inclusion of electric field detection sensors as part of the Hybrid Smart Fire Extinguishment Encasement is important, so as to detect the presence of and avoid an open or live electrical line proximate to or in the encasement's trajectory (U.S. Pat. No. 6,922,059).

The use of multiple collision and obstacle detection and avoidance systems and other sensors presents a concern where the detection characteristics of one system differs from that of another, as cited at U.S. Pat. No. 6,055,042. The Hybrid Smart Fire Extinguishment Encasement will require a method and system to compensate for these characteristic differences and various external factors. Therefore, whether interpreting the differences of touch sensors, infrared sensors, ultrasonic sensors, laser sensors, vision sensors, ultra-wide band radar, RF, laser and other detection means, the ability to provide a system by which the Hybrid Smart Fire Extinguishment Encasement's intuitive system can conform such data into one format will provide an efficient system for close quarter fire combat operations (U.S. Pat. Nos. 6,867,727, 6,903,676).

While Ser. No. 20050139363 discusses a number of construction options for Fire Suppression Delivery System fire extinguishment encasements, U.S. Pat. No. 6,619,029 addresses the need to compensate for the difference in temperature between the storage-state and launch state of a projectile, which may need to be addressed here. However, it does not address the need of the Hybrid Smart Fire Extinguishment Encasement's thermal tolerance threshold to be higher than that of other fire extinguishment encasements, given the need to endure (prolonged) exposure to extreme heat conditions within a fire environment. Operation of a Smart Fire Extinguishment Encasement requires the dissipation of heat away from its propulsion means, power source, components, and the fire extinguishment load contained therein.

The Hybrid Smart Fire Extinguishment Encasement can be constructed as a unitary structure, segmented or as a modular structure. U.S. Pat. Nos. 6,840,480 and 6,056,237 discuss the advantages of modular construction and the ability to readily change out components as needed. The ability to change out components and to fit an encasement by needs, as opposed to creating an entire line of specific, limited situation Hybrid Smart Fire Extinguishment Encasements should provide flexibility at the manufacturing, application and upgrade stages, respectively.

### SUMMARY OF THE INVENTION

One object of this invention is to modify the Fire Suppression Delivery System's smart fire extinguishment encasement to include drone-like (unmanned aerial vehicle) capabilities, by fitting it with a mini propulsion means, canards and other systems for navigation and trajectory control, for fire suppression purposes: creating a Fire Suppression Delivery System Hybrid Smart Fire Extinguishment Encasement.

Another object of this invention is to develop the Hybrid Smart Fire Extinguishment Encasement, where its navigation and trajectory, search, targeting and discharge controls can be programmed by manual input and based upon structural and fire scan data identifying structural, fire, accessibility and access route(s).

Another object of this invention is to equip the Hybrid Smart Fire Extinguishment Encasement with forward, lateral, vertical and rear obstacle and collision avoidance scanning and software, with the ability to conform the pre-launch scan data format used for navigation and trajectory control with that of onboard structural and thermal scanning and sensory data.

Another object of this invention is to develop the Hybrid Smart Fire Extinguishment Encasement where its navigation and trajectory, search, targeting and discharge controls work in conjunction with an onboard structural and scanning means to determine its position at all times relative to the structure, access route, obstacles, fire and other Fire Suppression Delivery System fire extinguishment encasements; identify, determine the position of, size and projected pathway of non-stationary obstacles and projectiles; and, to avoid obstacles and collision, while maintaining its trajectory, navigation, search and targeting program.

Another object of this invention is to develop the Fire Suppression Delivery System Hybrid Smart Fire Extinguishment Encasement so that where access to the target area is blocked by, e.g., a barrier such as a wall, door, floor, ceiling, etc., the onboard system and intuitive or intelligent software will determine the position of the fire within same, determine the most likely or potential area(s) of the barrier that will or can be breached; determine the accessibility and access route leading to the target fire zone or the anticipated breach area, fire and obstacles, as identified by use of the structural and fire scan data, then on programming and launch to navigate the structure.

Another object of this invention is to develop the Fire Suppression Delivery System Hybrid Smart Fire Extinguishment Encasement so that where access to the target fire zone is blocked upon arrival or approach of the Hybrid Smart Fire Extinguishment Encasement, such will continue scanning of the immediate area, fire, and perform an assessment of the original estimate breach point data and programming to determine whether to hover while awaiting access or to attach to a surface area and temporarily reduce propulsion requirements subsequent to surface attachment. Subsequently, the system will scan to determine a suitable surface to attach to and continue its scanning functions until the required breach of sufficient clearance does occur, so as to resume required propulsion needs, detach from the surface and proceed to the target fire zone; and, where collision avoidance detection indicates the approach of debris or a projectile, to disengage from its surface attachment or hover position, adjust its trajectory to avoid collision, and either reattach/hover at a suitable position or enter the target area accordingly.

Another object of this invention is to develop the Fire Suppression Delivery System Hybrid Smart Fire Extinguishment Encasement so that where access to the target zone is not blocked and/or the obstructed area is sufficiently breached to permit access, the Hybrid Smart Fire Extinguishment Encasement will access the target area and discharge its fire extinguishment load accordingly.

Another object of this invention is to develop the Fire Suppression Delivery System Hybrid Smart Fire Extinguishment Encasement is to extend the capacity of the smart encasement to hover and discharge or discharge its fire extinguishment load on-the-fly, permit vertical stacking or staggered stacking discharging and horizontal canopy discharge by deploying multiple Hybrid Smart Fire Extinguishment Encasements.

Without limiting the scope of the invention a brief summary of some of the claimed embodiments of the invention is set forth below. Additional objects, advantages, and novel features of the invention will become apparent to those skilled in the art upon examination of the following description or may be learned by practice of the invention. The present invention has a wide range of applications and is therefore not limited to the summarized embodiments of the invention and/or additional embodiments of the invention found in the Detailed Description of the invention below.

### DETAILED DESCRIPTION OF THE FIGURES

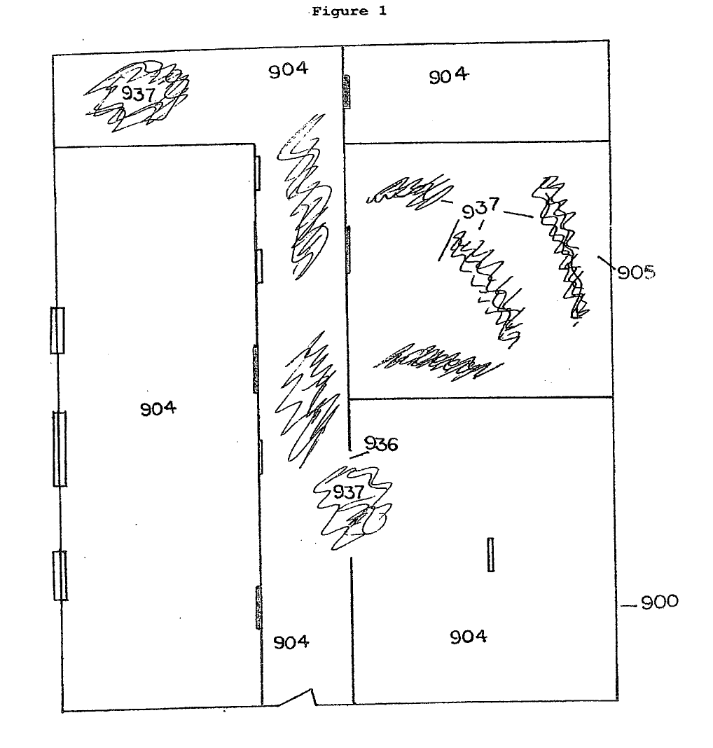

FIG. 1 illustrates a (primary) structure comprising a substructure, containing a fire within both areas. Here, the containment walls of the substructure have not been breached by the fire, firefighters, and all accessways to same are closed (thereby, preventing access to the interior of the substructure by encasements launched to or within the structure).

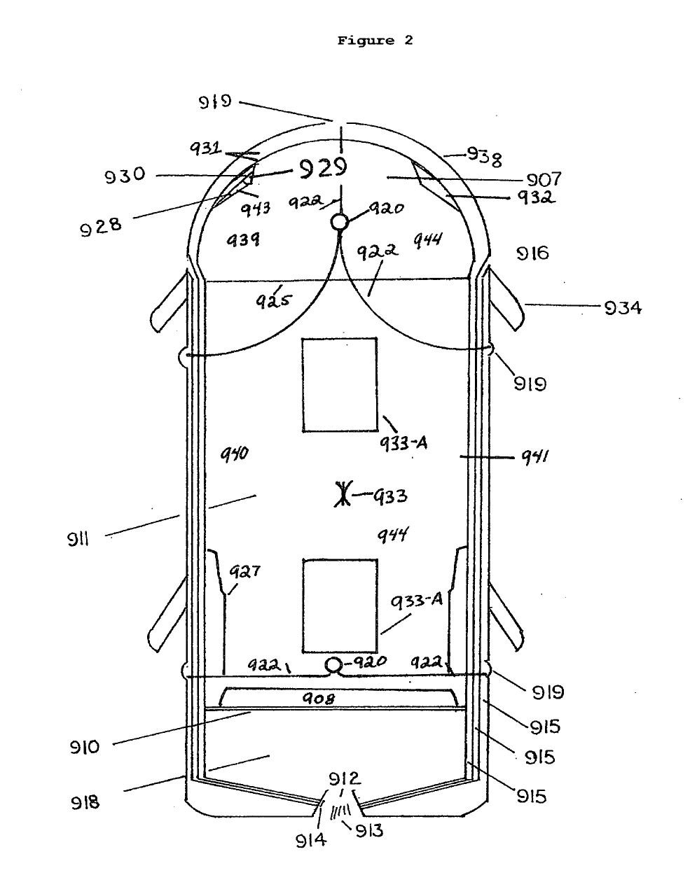

FIG. 2 illustrates a smart fire extinguishment encasement fitted with a mini-propulsion means, canards and stabilizing fins: forming the Hybrid Smart Fire Extinguishment Encasement.

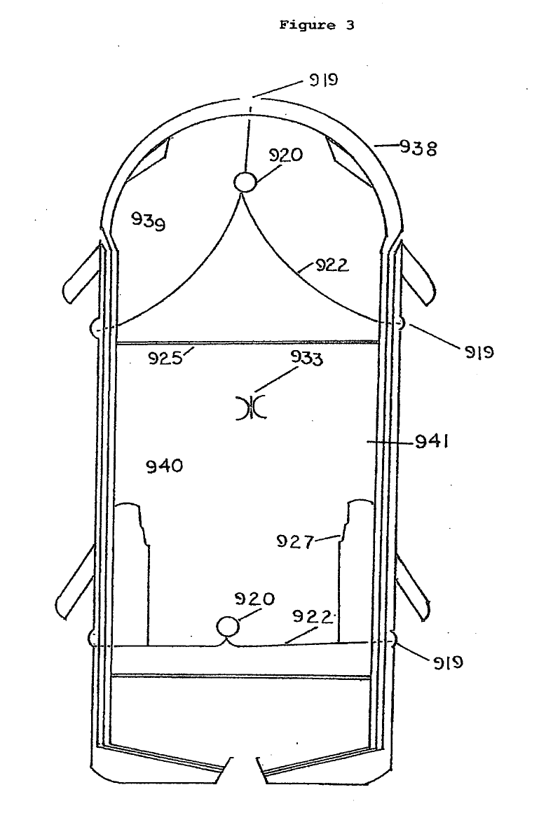

FIG. 3 illustrates a Hybrid Smart Fire Extinguishment Encasement modified for the delivery and discharge of foam firefighting materials.

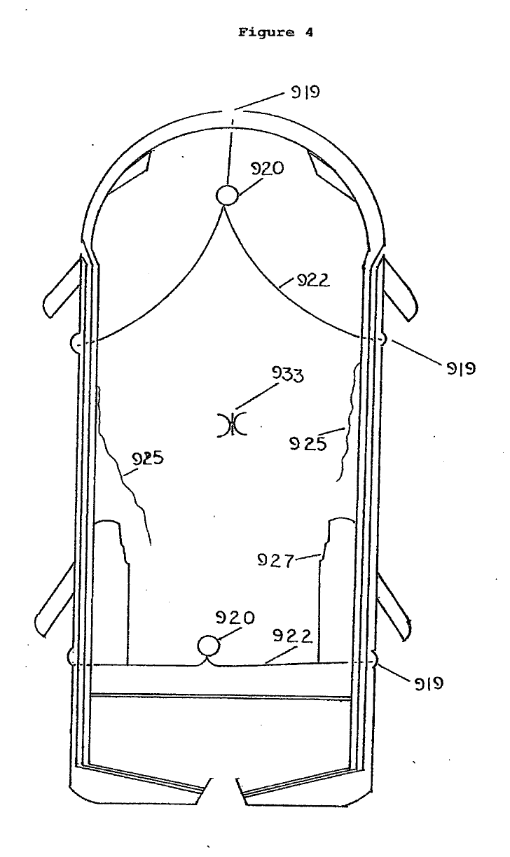

FIG. 4 illustrates a Hybrid Smart Fire Extinguishment Encasement modified for the delivery and discharge of foam firefighting materials, where the separation barrier has been compromised to permit mixing of the foaming firefighting material and its mixing medium.

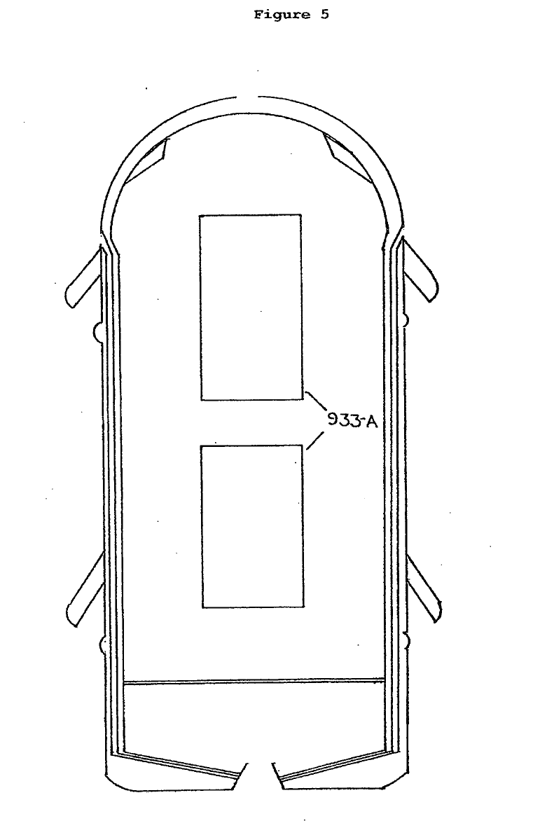

FIG. 5 illustrates a Hybrid Smart Fire Extinguishment Encasement with an overview of its fire extinguishment containment capacity.

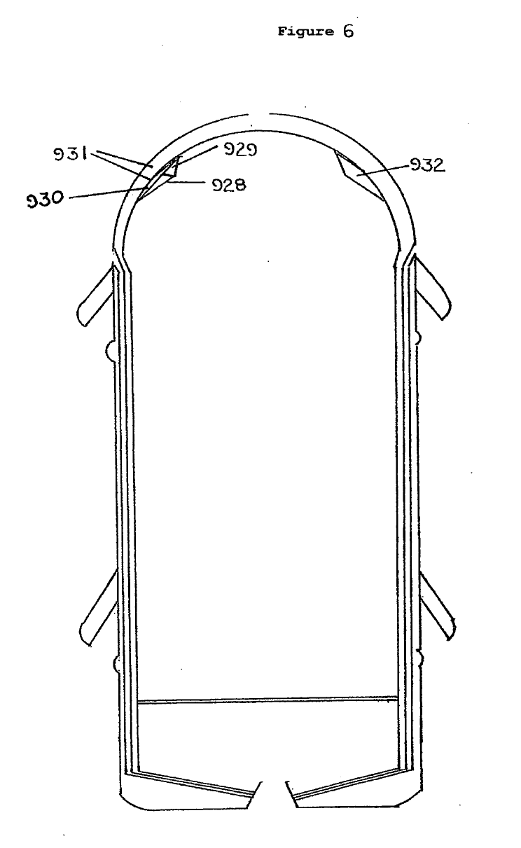

FIG. 6 illustrates the Hybrid Smart Fire Extinguishment Encasement fitted with an activatable magnetic surface for attachment of the encasement to a surface.

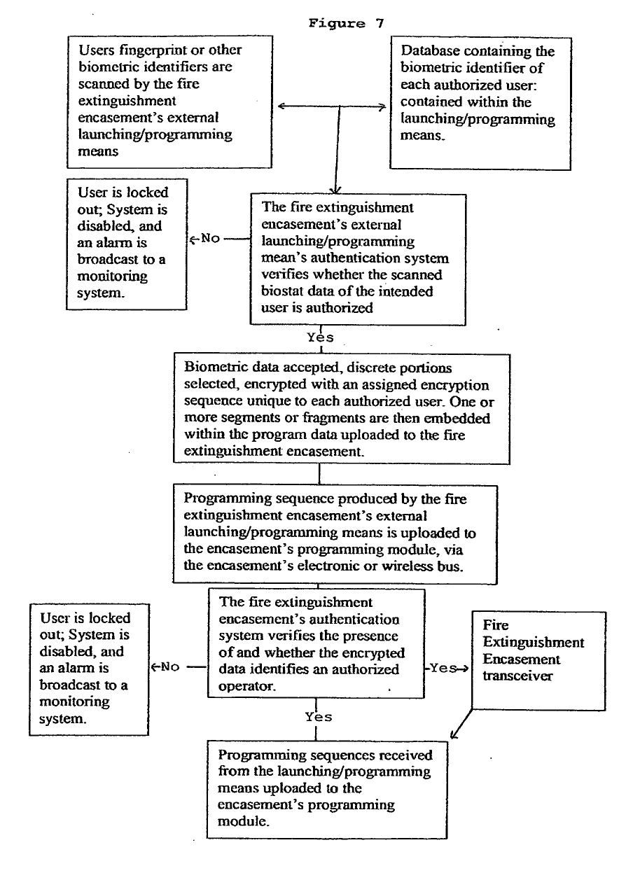

FIG. 7 is a block diagram illustrating the programming software feature of the Fire Suppression Delivery System, and more specific to the operation of the Hybrid Smart Fire Extinguishment Encasement.

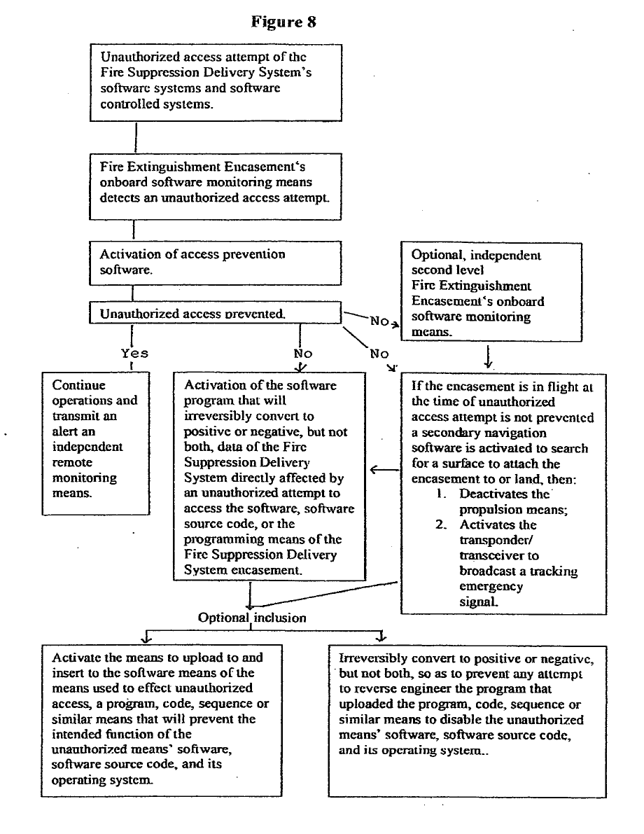

FIG. 8 illustrates a block diagram of the software security means.

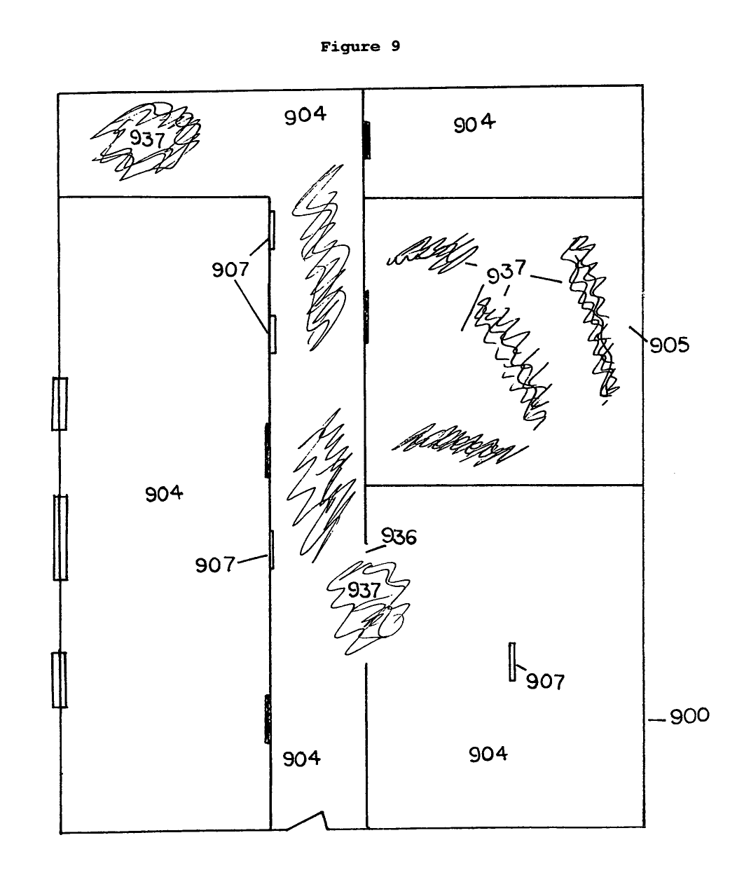

FIG. 9 illustrates a (primary) structure comprising a substructure, containing a fire within both areas. The containment walls of the substructure have not been breached by the fire, firefighters, and all accessways to same are closed (thereby, preventing access to the interior of the substructure by encasements launched to or within the structure). Here, the Hybrid Smart Fire Extinguishment Encasement utilizes the structural and fire scan data to navigate the structure. While awaiting a breach in the substructure's containment wall(s) to provide access to its interior, it will hover or attach to a metallic surface, and continue to scan the structure, substructure and fires therein.

### DETAILED DESCRIPTION OF THE INVENTION

As used herein, a fire situation, fire environment, fire situation, fire zone or fire conflagration, (used interchangeably, unless specified otherwise) shall mean the place, environment, area or ecosystem where a fire exists, is active, is anticipated, or has existed but requires continued monitoring. Such terms may also be used interchangeably with fire, target, target area, or target zone.

As used herein, a fire extinguishment material, a fire suppressant material, a fire retardant material, an endothermic agent, shall be defined as a powder, granular, solid, aerosol, misting material, atomizing mist, foam firefighting material, inert gas, gaseous substance, or similar material, in a compressed or non-compressed state, or other suitable substance, with suitable characteristics for fire extinguishment, fire suppression, fire retardant, particulate matter suppression and/or dispersal, the capacity to reduce the temperature within a fire zone when delivered to and activated within a fire environment, and or to extinguish or suppress a fire in said environment, respectively, and may interchangeably be referred to as a “fire suppressant” or “fire extinguishment” unless specifically noted otherwise.

As used herein, foam firefighting material shall be the means comprising the substance or material required for produce same, as known to those skilled in the area of fire extinguishment material production.

As used herein, foam firefighting material mixing agent shall be the means comprising the substance or material required for mixing with foam firefighting material that will produce a viable foam firefighting substance, as known to those skilled in the area of fire extinguishment material production.

As used herein, acceleration of the foam formation ratio shall mean the injection of a gas, inert gas, air or other means into the foam agent, subsequent to mixing of the foam firefighting material with its fluid activation medium, so as to significantly increase its foam formation ratio prior discharge to the environment.

As used herein, the phrase “off the deck” shall mean above the floor, ground or surface.

As used herein, electronic programming or programming of a fire extinguishment encasement shall be the means comprising but is not limited to, the use or application of technology, a device, program, software, circuitry, wireless system, electronic program, transceiver, communication bus or similar technology and means, that will permit an electronic signal to be transmitted to and received by the encasement's programming means or module, so as to program the software and electronic components and other systems or features of the fire extinguishment encasement.

As used here in this invention, a transceiver shall be a means comprising a device or similar system capable of receiving electronic programming signals from an authorized programming means external to the fire extinguishment encasement; and, where so programmed, can transmit information and data to an authorized monitoring means, as well as other fire extinguishment encasements.

As used herein, a structure shall mean (including but not limited in definition or application) a surface or land based facility such as a commercial, residential, industrial, mixed use or similar building; an underground facility, such as a tunnel, communications tunnel, underground transportation structure; marine, submersible, semi-submersible underwater structure; or, an aerial platform: which is accessible to, inhabitable by or similarly occupied by persons or animals, and where such structures can sustain a combustible atmosphere, to which a fire or explosion could occur, and to which a fire could be sustained within.

As used herein, the mention of a ceiling, wall, floor, void, opening or similar designation shall be the means comprising such elements that are common to a structure.

As used herein, sub-structure or similar notation shall mean an area within a structure comprising a room or area comprising its own compartment or compartmentalized area, semi-compartmentalized area or an area otherwise bound by the structure, to which entry to same would be through a door, window or other opening within the structure but not necessarily accessible to firefighters through an exterior opening of the structure.

As used in this invention, a target or target area shall be a means comprising a fire zone, fire environment, fire, position of the fire, position within a fire or fire situation that has become, is or will be identified as the point, location, pathway, path or similar position that fire extinguishing action will be directed to.

As used herein, a primary target shall be a means comprising a specific fire zone, specific fire environment, specific fire, specific position of the fire, specific position within a fire or specific fire situation that has become, is or will be identified as the point, location, pathway, path or similar position that fire suppression action will be directed to.

As used herein, discharge or release of a fire extinguishment encasement, shall mean but is not limited to, an action by which the contents of a fire extinguishment encasement will be or become discharged, ejected, ejected from, expulsed, expelled, forcibly expelled, emptied from, projected from, propelled, propelled from a fixture, device, containment device, containment system, or containment means to the external environment.

As used herein, delivery of a fire extinguishment encasement, smart fire extinguishment encasement, hybrid smart fire extinguishment encasement or fire extinguishment material shall be the means comprising a means, method, methodology, way, or similar manner to present, present into, place, drop, aerially drop, project, propel, throw, or suspend the extinguishment encasement into, within, above, discharge or suspend an encasement within or proximate to a fire environment.

As used herein, discharge of the fire extinguishment contents from a Smart Fire Extinguishment Encasement shall be a means comprising the use of ports, gas emitting ports, ejection ports, ejectors, channels, openings, means, nozzles, apertures, methods or similar descriptions, that will allow for release of a fire extinguishment material from the fire extinguishment containment area of the fire extinguishment encasement to the environment.

As used herein, discharge of a fire extinguishment encasement from a launching means shall mean but is not limited to, an action comprising the means by which an encasement will be or become discharged from, discharged by, ejected, ejected from, expulsed, expelled, projected from, propelled, propelled by, propelled from a fire extinguishment encasement's launching means.

As used herein, fire topography shall be a software process, database and memory means comprising scanning means' data of the fire zone, providing a two-dimensional or three-dimensional map of the layout of the structure and the fire's thermal pattern, as well as the fire's spatial relationship to the structure. The scan data generated and fire topography mapping may then be used, in conjunction with the appropriate software means, to determine but not limited to, the number of encasements and the fire-extinguishing load required to extinguish the fire, optimal and optional modes of attack, search, navigation, trajectory and discharge and other parameters of the fire extinguishment encasement.

In an embodiment, FIG. 1 illustrates a structure (900) where the primary fire (target) area (901) is accessible to firefighters either entering the structure, or by external access (e.g., window, door) or where breach of the containment area (905) permits access to combat the fire. Here, the containment area is referred to as walls, roof, floors, ceiling, etc. As further illustrated here, is an area or room within the structure, where a fire exists within same but where an open accessway is not available to firefighters or a smart fire extinguishment encasement: a breach in this substructure's containment wall (935) has yet to occur. The concern here is the existence of a fire deep set in a structure (900), that is beyond the reach of firefighters using standard firefighting techniques and the trajectory of a smart fire extinguishment encasement, that exists, e.g., behind closed doors: exposing firefighters to greater risk to create an access to the substructure while first traversing an evolved fire in the primary structure (900), or the risk of greater damage by awaiting a natural breach in the sub-structure to occur by way of the fire. Data generated by the structural and fire scanning means of the encasement's launching means to produce a two-dimensional and a three-dimensional map of the structure and the fire's thermal topography will show the structural layout, including that of the substructure; the fire within the primary structure area and the substructure, as well as the position of same relative to the substructure's containment wall(s). This will be incorporate into the encasement's navigation, trajectory and discharge programming data.

As used herein, navigation control means, shall be a means comprising accelerometers; actuators, MEMS, gyroscope, IMUs, onboard sensor and onboard reference, altimeters, GPS (for non-structural, above ground application, until such advancements will permit use of GPS within a surface structural, and within an underground/water structure) and other appropriate means, where for navigational control purposes of this invention are such devices that are in a practical state of development and well known to those skilled in the art of projectile, aircraft, unmanned aerial vehicles, and miniature aerial vehicle development.

As used herein, a guiding means shall be a means comprising the use of, application, incorporation, function of a system, method or similar means, software, wireless, electronic means and encasement features such as, but not limited to canards, projectile airbrake systems, propulsion means, to set the range, distance, altitude, height, depth, trajectory, trajectory pattern, path to assist, guide, direct, steer, manage, orient an encasement, by providing a link between the systems, means, devices to receive, send and share such information, and to respond according to programming, for the purpose of guiding the encasement from Point A to Point C, while traveling through Point B, and discharge its contents to a specific or general target, and while working in conjunction with its scan and sensor data, information and programming to perform corrective orientation and targeting of the encasement.

As used herein, an activatable means of the Fire Suppression Delivery System fire extinguishment encasement shall be a means comprising a method, methodology, mechanism, procedure, mechanical provision or similar means that when activated, will cause the encasement or its component to perform in the manner designed for.

As used herein, a fire extinguishment encasement is defined as a form of encasement, encapsulation, capsule, or similar containment means, which may also be referred to but not all inclusive of, a canister, device or something of similar designation or meaning, that may be constructed of a means comprising metal, a non-metal substance, gelatin, cellulose, plastic, polycarbonate, glass with polycarbonate, fire suppressant material, fire retardant material, an endothermic agent, composite material, other suitable medium or in combination thereof, with appropriate mechanical strength and disintegration rates and may be referred to interchangeably, that is intended to house, accommodate, contain, have, include, hold, surround, enclose, a fire suppressant material, fire retardant material, particulate matter dissipating agent, an endothermic agent, or in combination thereof, for the purpose of delivering same to a fire situation, where delivery of a fire extinguishment encasement includes the means comprising the means, method, methodology, way, ways, or similar manner to present, present into, place, drop, aerially drop, project, propel, throw, or suspend an encasement into, within, above, proximate to a fire environment.

As used herein, a Smart Fire Extinguishment Encasement shall mean a fire extinguishment encasement comprising a means that operates in conjunction with the structural and fire zone scanning means, from which the structural dimensions, coordinates and layout can also be determined from the scan data, also comprising the appropriate software, software processing means, operating systems, memory and database means, to produce a two-dimensional and/or three-dimensional layout, map, grid of the structural area and the fire's topography, with the ability to identify and avoid obstructions and barriers, and programming data generated from an external encasement programming means and internal data generated by its onboard scanning means.

This shall further mean, an encasement comprising smart technology capable of but not limited to identifying the target fire or fire zone(s) as programmed, the optimal routes of access to same, with the trajectory, navigation and propulsion (control) means to travel from the point of launcher discharge, through the structure or area to the target fire zone, while identifying and avoiding obstructions enroute, with the ability to discharge its fire extinguishment material load to the fire as specified.

This shall also mean, an encasement comprising a means using smart technology that is electronically and/or manually programmed with a software program(s) where its guidance (trajectory, navigation, collision avoidance, search) and fire extinguishment discharge means utilizes scan data to identify and locate the target fire area.

As also used herein, the Smart Fire Extinguishment Encasement shall mean an encasement system utilizing smart technology further comprising the capacity to be electronically and/or manually programmed, to search for, target, and deliver to and discharge a fire extinguishment to the fire. To achieve this end the smart encasement would be an encasement comprising onboard structural and fire scanning means to produce an active scan of the structure immediate to the pathway of the encasement, performs continued structural and fire zone scanning, including obstruction detection and avoidance scanning while the smart encasement is in flight to the target area. The data gathered as a result of the real-time on-board scanning system, working in conjunction with the appropriate software, would compare the new onboard scan data with that of the initial or programming scan data, looking for changes within the fire environment that would affect the encasement's trajectory, obstruction avoidance, targeting, or discharge, and allow the Smart Encasement to make in flight trajectory adjustments upon detection of structural changes or the presence of new obstructions, structural, or fire zone access changes.

As used herein, a hybrid smart fire extinguishment encasement is a smart encasement that is modified to include drone-like flight capabilities, providing for but not limited to, activation of a micro or mini propulsion means to sustain horizontal and vertical trajectory, lateral turning and flight, maneuverability to and within a structure or sustained trajectory or hovering beyond the capacity of a non-propulsion assisted smart fire extinguishment encasement: referred to herein as a Hybrid Smart Fire Extinguishment Encasement.

As used herein, a Hybrid Smart Fire Extinguishment Encasement shall also mean a smart fire extinguishment encasement comprising the means that it can be projected to a fire situation with or without activation of the propulsion means. Wherein, when activated, the propulsion means will sustain horizontal and vertical trajectory beyond the capacity of non-propulsion assisted smart fire extinguishment encasements.

As also used herein, a Hybrid Smart Fire Extinguishment Encasement shall also mean a smart encasement comprising the means by which the structural and fire scan data, with linkage to the appropriate software means, will be used by its programming means to determine the optimal and alternate route of access from the position of its launching and/or external programming means to the target fire area. Where a fire exists within a sub-structure or area that is not readily accessible to firefighters, i.e., lack of an open access way or the fire has not penetrated the containment wall(s) of a room so as to create access, the encasement's onboard systems utilizing its structural and fire scan data to navigate to the nearest optimal position of potential or anticipated entry, will hover or attach to a surface area and where it can remain in an active scanning mode while awaiting access: where it can monitor the fire and determine where a suitable breach will occur and when.

As used herein, the Hybrid Smart Fire Extinguishing Encasement shall mean a smart fire extinguishment encasement system comprising a program to navigate the area of the structural fire and its fire topography, with real-time obstruction avoidance guidance and an on-board structural and fire scanning system, linked to a software program and memory that contains the two-dimensional and three-dimensional structural layout and fire topography data, so as to perform a real-time comparison of the (look forward) scan to that of the structural scan data in its memory. By comparing the real-time (look forward) scan data and the pre-launch trajectory program, trajectory corrections would be performed by the encasement's navigation system in the pathway of new obstructions caused by debris, explosion or fire.

As used herein, the Hybrid Fire Extinguishment Encasement onboard systems shall be the means comprising, but not limited to, the structural and fire scanning means linked to its navigation, trajectory, collision detection and avoidance, propulsion control, search, targeting, thermal differentiation and discharge controls, object recognition and structural feature data recognition software and its database objects common to a fire zone, transceiver, sensors, and software and other means containing the programming data and its two-dimensional and three-dimensional structural layout database.

As used herein, an impact discharge fire extinguishment encasement, the standard, basic, non or limited smart technology fire extinguishment encasement shall mean a fire extinguishment encasement system comprising limited smart technology with the capacity to be electronically or manually programmed to search for, target, and extinguish a fire. This encasement, using limited smart technology, that is electronically or manually programmed from a software program that can utilize structural and fire scan data to produce a two-dimension and a three-dimension grid, map or layout of the structural area and the fire's topography, will deliver to and discharge its fire extinguishment payload based upon such factors as, but not limited to, height, spatial relationship, altitude, temperature, thermal range, time, time out of the launcher, distance, global positioning system coordinates, or flame detection settings, or impact.

This shall also mean a fire extinguishment encasement system that does not comprise heat seeking technology but can be linked with thermal sensors or similar means, and programmed to detect and target a specific temperature or temperature range in an open or discretely defined area; that can differentiate incremental temperature differences as well as distinguish a higher or lower thermal target while within or passing through a conflagration, or otherwise high temperature area normally associated with a conflagration.

This shall further mean a fire extinguishment encasement utilizing impact as the primary or secondary cause of fire extinguishment material discharge, designed to discharge upon impact with a surface at X^{psi}: where X^{psi} is the amount of pressure exerted per square inch when the encasement impacts with or is struck by a surface force greater than that encountered, subsequent to when an encasement is discharged from a launching means, the pressure exerted when loading the fire extinguishment and/or propellant, incidental bumping, and storage exerted pressure.

As used herein, non-controlled degradation, impact degradation, secondary discharge degradation, and degradation of a fire extinguishment encasement based upon impact shall be the means comprising the intentional, purposeful, deliberate discharge, release, destabilization, disintegration, degradation, rapid degradation of a fire extinguishment encasement fire extinguishment resulting in the forceful expulsion, release, discharge, projection, propelling of fire extinguishment from the fire extinguishment encasement to the environment, where such degradation is the result of an intentional, discrete, or complete disruption of the encasement's wall structure based upon pre-set discharge parameters such as time, specified temperature, specified thermal range, thermal differentiation, distance, height, altitude, Global Positioning System settings, target acquisition, thermal target acquisition, target proximity, or in any combination thereof, as programmed into the encasement's programming, navigation, security, and discharge means, or by impact of the fire extinguishment encasement with second a surface area at X^{psi}, where X^{psi} is the amount of pressure exerted per square inch when the encasement impacts with or is struck by a surface force greater than that encountered when an encasement is discharged from a launching means, or the pressure exerted when loading the fire extinguishment and/or propellant, incidental bumping, and storage exerted pressure.

As used herein, controlled degradation of a fire extinguishment encasement shall be the means comprising the intentional, purposeful, deliberate discharge, release, destabilization, disintegration, degradation, rapid degradation of a fire extinguishment encasement, resulting in the forceful expulsion, release, discharge, projection, propelling of fire extinguishment material from the encasement to the environment, where such degradation is the result of an intentional, discrete, or complete disruption of the encasement's wall structure, nozzles, ports, strategically placed openings or similar surface openings, based upon pre-set, programmed controlled degradation and discharge parameters such as, but not limited to, time, temperature, specified thermal range, thermal differentiation, distance, height, altitude, Global Positioning System settings, altimeter reading, target acquisition, thermal target acquisition, target proximity, the use of scan data from the structural and scanning means to produce a two-dimensional and three-dimensional structural and fire topography map of the target structure area, or in any combination thereof, as programmed into, but not limited to, the encasement's programming, navigation and discharge means, but not by impact of the encasement.

As used herein, controlled degradation of a fire extinguishment encasement shall also be the means comprising the discharge, disintegration, collapse, rapid collapse, intentional destruction of the fire extinguishment encasement, or discrete segment(s) of the fire extinguishment encasement, or through its nozzles, ports, strategically placed openings or similar surface openings, so as to effect immediate, rapid, destabilization, disintegration, destruction, by the use of an activatable means.

As used herein, a hybrid, controlled degradation fire extinguishment encasement shall mean an encasement comprising a construction where a portion of the fire extinguishment material containment area may disintegrate under controlled degradation conditions, to discharge the extinguishment to the environment through discrete, strategically placed port areas of the fire extinguishment material containment area; or, where the encasement containment area, separate from the propulsion means (containment) area may discharge its load in the same manner as a non-controlled degradation or impact fire extinguishment encasement.

As used herein, a heat resistant or heat stable fire extinguishment encasement shall be a fire extinguishment encasement comprising a material, substance or construction where its exposure to extreme temperatures associated with a fire zone will not result in disruption of the encasement's structural integrity or function.

As used herein, reinforcement of the fire extinguishment encasement shall be a means comprising a material, substance or construction that will significantly reduce or prevent damage to the encasement that may be caused by debris or by contacting surfaces enroute to and within the structure and fire zone.

As used herein, an electromagnetic interference shielding shall be a means comprising a coating, substance, device, mechanism or similar means that will protect the component of the encasement, electronic and data reception and transmission of an encasement from the electromagnetic energy generated by or proximate to a fire zone, that may otherwise damage semiconductor and other electronic components and signal processing circuitry that is found within, and interfere with or prevent proper function and operation of the encasement.

As used herein, the propulsion means of the Hybrid Smart Fire Extinguishment Encasement shall be a means comprising a device, system, mechanism or similar means placed within or made a part of the encasement, that when activated, will provide a continuous method of propulsion and trajectory control of the encasement.

As used herein, the propulsion means of the Hybrid Smart Fire Extinguishment Encasement shall also be a means comprising a device, system, mechanism or similar means placed within or made a part of the encasement, when linked to the appropriate power or propellant means, navigation, trajectory controls, and avionic system, and other appropriate software controls and is activated, will sustain horizontal and vertical flight of the encasement, and propel same to the fire zone.

As used herein, the propulsion means of the Hybrid Smart Fire Extinguishment Encasement shall also mean a mini or miniaturized propulsion means that has been reduced in size and scope for application within a Hybrid Fire Extinguishment Encasement.

As used herein, a canard shall be a means comprising a retractable or moveable device, mechanism, material or similar means that forms a horizontal stabilizing surface, that when activated and projected outward from the exterior of the encasement will control and stabilize an encasement's trajectory.

As used herein, a canard shall also be a means comprising a retractable or moveable device, mechanism, material or similar means that when activated will assist to steer the encasement.

As used herein, stabilizing fins shall be a means comprising a retractable or moveable device, mechanism, material or similar means, that when activated and projected outward from the exterior of the encasement will control the spin of and stabilize an encasement's trajectory.

In an embodiment, FIG. 2 illustrates a Hybrid Smart Fire Extinguishment Encasement (938) fitted with a mini-propulsion means (908), which can be housed within its own containment area (910) of the encasement, separate but contiguous to the fire extinguishment material containment area (911), whether powered by a miniature battery, compressed gas, propellant or other means. When the propulsion means is activated, its propulsion stream (912) can be released through the primary outlet (913) to support its horizontal trajectory, to which a portion can be shunted by diverters (914) through ducts (915) incorporated into the encasement to exit through actuator controlled ports (916). The diverted portion of the propulsion stream (912) is to support the encasement's horizontal, vertical, lateral, and nose-up trajectory, and turning. Through additional controls, fire extinguishment material can be released to the environment via the same ports. Here, canards (and stabilizing fins) (934) are depicted in an activated state, extended outward from the encasement's body, to provide spin stabilization, steering and turning of the encasement, and to serve as a projectile airbrake. When linked to the appropriate software means and the navigation and trajectory controls, the activatable means when activated will cause the actuators and MEMS to retract or extend the canards at the required angle for horizontal and vertical flight, turning and hovering of the encasement.

As used herein, a fire extinguishment encasement duct or ducting shall be a means comprising a device, method of construction or similar opening, through which exhaust or a propulsion stream can be directed from the Hybrid Smart Fire Extinguishment Encasement's propulsion means to the external environment, to effect sustained horizontal flight, projection, trajectory, vertical flight, hovering, or the combination of such flight controls.

As used herein, an exhaust or propulsion stream diverter or diversion means shall be a means comprising a device, method or similar means, that when linked to the appropriate software controlling the propulsion, navigation and trajectory means and when activated will divert a sufficient portion of the exhaust or propulsion stream from the propulsion means to ducts, channels or similar passages within the encasement to a duct or port area other than the primary exhaust area, so as to effect turning, stabilization, roll, turning of the encasement, or hovering (where hovering is effected by one propulsion means as opposed to a second or separate propulsion means) and other encasement maneuvers, without compromising stability and operation of the encasement's propulsion means.

As used herein, a fire extinguishment encasement channel or channeling shall be a means comprising a device, mechanism or similar means that forms a duct-like or channel structure within the body of the encasement, through which the exhaust or propulsion stream is diverted from the propulsion means to ducts or ports in the encasement area other than the primary exhaust area, so as to effect turning, stabilization, roll, turning or hovering of the encasement.

As used herein, a fire extinguishment encasement port(s) shall be a means comprising a device, mechanism or similar means strategically placed as a component of the encasement's structural body, that when activated will open to permit the release or expulsion of exhaust or propulsion stream, or the release of fire extinguishment to the environment.

As used herein, the propulsion stream shall be the pressurized flow of air, gas, fluid or fluid stream created by the propulsion means to propel the Hybrid Smart Fire Extinguishment Encasement.

As used herein, a fire extinguishment containment means shall be a containment means comprising an interior device, means or similar mechanism, to contain, house, accommodate, contain, include, hold, surround, enclose a fire suppressant material within the fire extinguishment encasement, for the purpose of delivering and discharging same (to a fire situation).

As used herein, the application of a mini or micro pump shall be a means comprising a device, means or similar mechanism that when activated will inject atmospheric air and/or compressed gas into the encasement's foam ejection nozzle(s), subsequent to mixing of the foam firefighting material with its fluid activation medium so as to pressurize the contents therein and/or to facilitate acceleration of the foam formation ratio and ejection, but immediate to its discharge through the ejection nozzle to the environment.

As used herein, a gas containment means shall be a means comprising a device, means or similar means further comprising pressured gas within the encasement, with connecting lines to ejection nozzles and/or to the fire extinguishment containment means.

As used herein, a gas containment means shall also be a containment means comprising the means that when activated by the software linked and controlled actuators and MEMS, will inject the gas from the containment means into the foam ejection nozzle subsequent to mixing of the foam firefighting source material with its fluid activation medium, yet immediate to its discharge through the ejection nozzle, so as to accelerate the foam formation ratio.

As used herein, the impermeable separation barrier within a fire extinguishment encasement shall be a means comprising a membrane, device or similar structure that will separate the foam material source from the fluid activation medium: constructed so that it will withstand the force exerted when loading the encasement with the foam material source and the fluid activation medium, and discharge of the encasement from its launching means. Its placement within the encasement will in part be determined by the volume of foam firefighting material and required fluid medium respectively, aerodynamic requirements of the encasement, and other factors.

As used herein, compromise of the impermeable separation barrier shall be a means comprising a way, action, means or similar act, that will cause the barrier to separate, collapse, or by similar manner disengage from its point(s) of attachment to the internal wall of the fire extinguishment encasement, but in such a manner as to not impede mixing of the foam firefighting material with its fluid activation medium, the mixing device, or the ejection nozzle, or its ejection to the environment.

As used here, the mixing means for the foam firefighting material shall be a means comprising a device, mechanism, process or similar means within the encasement, that when activated will mix the foam firefighting material with its fluid activation medium, prior to ejection of the mixed foam fire fighting material to the environment.

As used here, the ejection/mixing nozzle shall be a means comprising a device, mechanism or similar means through which upon activation of the appropriate means the mixed foam firefighting material shall be released from the encasement containment means and ejected trough the nozzle to the environment, where gas or air will be pumped with same under pressure to accelerate the foam formation ratio prior to ejection of the foam fire extinguishing material to the environment.

As used herein, an activatable magnetic surface means of the Hybrid Fire Extinguishment Encasement shall be a means comprising a surface area of the encasement that can be magnetized to facilitate attachment of the encasement to a metallic surface; to provide a stable platform and position from which the Hybrid Smart Fire Extinguishment Encasement's scanning means can perform its function; to await access to the substructure area, discharge its fire extinguishment material to the environment; and, where conditions permit to become demagnetized so as to allow the encasement to resume flight operations.

In an embodiment, FIG. 3 illustrates a Hybrid Smart Fire Extinguishment Encasement (938) for the delivery and activation of foam firefighting material. Here, the barrier (925) (attached to MEMS and actuators) separates the foam material source (939) from its fluid activation medium (940), that when mixed together will result in production of the firefighting foaming agent. The activatable means liked to the software control means of the MEMS and actuators, programming, trajectory, navigation and discharge means of the encasement will activate the device that will compromise the separation barrier: subsequent to discharge from the launching means, on approach to the target fire zone, or upon access the target zone, to initiate the device (933) to mix the foam material source with its fluid activation medium, that will mix the foam material source with the fluid activation medium, subsequent to degradation of the separation barrier (925). The ejection of air or gas (such as nitrogen) under pressure to the firefighting foam agent from the high pressured gas from the containment means (917) connected (922) to the ejection nozzle (919), controlled by MEMS and actuators (802) immediately prior to the discharge of foam through the ejection nozzle will accelerate the foam mixing and formation ratio as the foam is expelled to the environment.

Alternatively, the MEMS and actuators will activate a micro pump (920) or similar means that will draw air from the environment and inject such under pressure, to the ejection nozzle (919) and the firefighting foaming agent. Point 927 illustrates optional placement of the high pressure gas containment means for aerodynamic and trajectory balance purposes, with connecting lines to the ejection nozzle(s) (922, 919). Point 920 illustrates optional design inclusion of a micro pump to pressurize the encasement and its. contents, to facilitate foam formation and ejection, subsequent to discharge of the Hybrid Fire Suppression Delivery System encasement from its launching means. Here, the diagrammed barrier that bifurcates the Hybrid Smart Fire Extinguishment Encasement's foam firefighting material containment area (941), is shown in its current state for illustrative purposes only. Actual placement of the barrier (925) will depend upon specific design parameters and the required fluid medium to foam source material ratio: as too, the number of and placement of the ejection nozzle(s) (919).

In another embodiment, FIG. 4 illustrates a modified Fire Suppression Delivery System's binary Smart Fire Extinguishment Encasement where the barrier (925) that separates the foam material source from its activating fluid medium is compromised by activation of its MEMS and actuators, so as to facilitate mixing of the activation fluid with the foam material source, to produce the firefighting foaming agent.

As used herein, the structural scanning means shall include, but is not limited to, look-through scanning, Micro Impulse Radar, ultra-wide band radar, infra-red, thermal, thermal differentiation, optical, acoustical, forward looking, lateral looking, collision avoidance and laser scanning and radar means, and other scanning and radar means that may be modified and adapted to produce a non-invasive detection of the structure, and a two-dimensional and/or three-dimensional map of a structure and topography of the fire, and the location and identification of human subjects within the scanned area of the structure and its fire zones.

As used herein, the structural scanning means shall include, but is not limited to, the means comprising a system that is further linked to a memory device and database comprising a processing device which includes a library of known characteristics of high-rise, commercial, residential and industrial structure, communication tunnels, underground transportation infrastructures, its voids, barriers, barrier walls, walls, multiple walls, open spaces, openings such as doorways, halls, chases, shafts, and other spaces, objects, obstructions and structures common to such building/structures and target fire structure.

As also used herein, the structural scanning means shall be the means comprising the modification of systems that can be adapted for use in or as an onboard scanning means of a smart encasement, for scanning a structure or fire zone to determine the layout of the structure, the presence and position of the fire, that when linked to the appropriate software that will result in non-invasive detection and produce a two-dimensional and/or three-dimensional map of a structure and topography of the fire; to determine and where necessary, when working in conjunction with the appropriate trajectory and navigation software and controls, will compare, adjust or conform the trajectory, and navigation of the encasement through the structure to the targeted fire or fire zone, utilizing scan data, trajectory, and navigation programming instructions programmed to the encasement prior or subsequent to discharge of the smart encasement from its launching means.

As used herein, thermal differentiation and thermal differentiation scanning shall mean a structural and fire scanning means comprising the appropriate software and software linkage, with the capacity to differentiate incremental temperature differences, as well as distinguish a higher or lower thermal target upon approach, within or passing through a conflagration, and can differentiate the thermal pattern of a human subject in or near a conflagration from the thermal pattern of the conflagration itself.

In an embodiment, FIG. 5 illustrates a Hybrid Smart Fire Extinguishment Encasement fitted with a magnetic surface area (933-A), that when activated can be magnetized to facilitate attachment of the encasement to a metallic surface: to provide a stable platform and position from which the Hybrid Smart Fire Extinguishment Encasement's scanning means can perform its scan function; to await access to the substructure; discharge its fire extinguishment material to the environment; and, where conditions permit to become demagnetized so as to allow the encasement to relocate to a new position, to resume operations or exit the structure (or substructure).

As used herein, the Fire Suppression Delivery System's smart technology security means shall be a means comprising a scanning, imprinting and encryption means to produce a fingerprint or other biometrical identifier data unique to each authorized user, that will be verified, digitized and electronically stored within the encasement's launching mean's memory system prior to usage of the System. The launching/smart programming means would contain the encrypted data of each authorized user, so that upon use of an encasement's external programming means, such data must again be verified to indicate the user is authorized, whereupon a discrete portion of that encrypted data will be uploaded to the Smart Fire Extinguishment Encasement launcher's database and programming means. When the encasement is programmed, the same encrypted data must be uploaded to the encasement's internal programming means and the encasement's transceiver memory means. Before the encasement can be discharged from its launching means the encrypted data, whether by the same or a different authorized user, must be verified and embedded into the programming data, then verified by the launching means before it can be discharged from the latter. Thus, if a launcher is operated by a System authorized user, the launcher's memory means recognizes the new authorized user, then allows the latter to operate the System. An unauthorized user would be prevented from operating the System, while at the same time and where possible to produce, a digitized print of the unauthorized user. (The digitized print from the unauthorized would be immediately relayed to a remote monitoring and alert system. Having a digitized print of the unauthorized user would allow for tracking, identification, and where necessary, prosecution).

As used herein, the Fire Suppression Delivery System's smart technology security means shall similarly include the encasement's transceiver means, further comprising a database of all authorized System users and encryption verification means, so that to modify the encasement programming instructions post discharge from its launching means but prior to discharge of its fire extinguishment material, the transmitted signal received by the encasement's transceiver must include embedded authorized user identifiers that must be accepted and verified by the transceiver before the signal can be loaded from the transceiver to the encasement's onboard programming means.

As used herein, the Fire Suppression Delivery System's smart technology security means shall also be a means comprising a programmable software system linked to a memory means comprising encrypted digitized Fire Suppression Delivery System (e.g., fingerprint) biometrical identification segment(s) of all authorized operators, so that its transmission signal means can only be received by a Fire Suppression Delivery System equipped to verify an authorized operator's encrypted digitized biometrical identification segment(s), and where the transceiver can only receive an externally generated signal containing an authorized operator's encrypted digitized biometrical identification segment(s).

In an embodiment, FIG. 6 also illustrates the Hybrid Smart Fire Extinguishment Encasement's application of the security verification module (928) that is linked to the programming module (929) and the transceiver (930). The security verification module's software must authenticate the receiving programming sequence as transmitted by an authorized user, via the presence of encrypted identifier data embedded within same, before the encasement can be programmed. Here, the encasement's internal programming means, when linked with the appropriate software, will control the navigation, trajectory, propulsion, search and scan, discharge and other aspects of the encasement. The encasement's onboard programming means is linked to the memory and processing means containing the a two-dimensional and/or a three-dimensional map of the structure and the fire's thermal topography, that will be used for navigation through the structure (and substructure), will be processed by the encasement's appropriate software means to compare its onboard scanning means (structural and fire, lateral, forward looking [radar], obstruction detection, collision detection and avoidance and other) scan data, so as to navigate through the structure (and substructure) for the purpose of targeting and extinguishing the fire therein. The onboard scanning means, sensors, and its database (932) are linked to the onboard programming module (929). The communication bus (931) also serves as a controller that will embed an authorized user code into any signal transmitted by the transceiver, preferably utilizing a restricted spectrum/radio frequency or similar means, which must be authenticated by the receiving means.

In another embodiment, FIG. 7 is a block diagram illustrating the programming software feature of the Fire Suppression Delivery System, and more specific to the operation of the Hybrid Smart Fire Extinguishment Encasement, where an authorized System operator's identifier(s) is scanned and verified by authentication with the database containing the identifiers of all authorizer operators. Upon authentication as an authorized operator, a discrete segment(s) of the biometrical (or other) identifier is encrypted, segmented, then embedded within the program sequence that will be uploaded to the Hybrid Smart Fire Extinguishment Encasement. When the programming data is transmitted to the Hybrid Smart Fie Extinguishment Encasement's electronic or wireless communication bus, the encasement's onboard verification system must first identify then authenticate the embedded sequence (to be) contained within the programming sequence. Failure to identify or to verify authenticity will result in the Hybrid Smart Fire Extinguishment Encasement's refusal to accept the transmitted program. Where the embedded encrypted is verified and authenticated by the onboard verification system, which is linked to an internal database comprising the encryption code unique to each authorized operator, the transmitted programming data is then uploaded to the Hybrid Smart Fire Extinguishment Encasement's programming module. Here, where a new or modified programming sequence is transmitted to the Hybrid Smart Fire Extinguishment Encasement, post discharge from its launching means, the transceiver that is linked to the onboard verification means must receive a return signal indicating the sequence is from an authorized System operator before it will be uploaded to the encasement's programming module.

As used herein, the Fire Suppression Delivery System's Software Security means shall be a means comprising a method, software program, provision, conveyance, technique or similar means that is software, microprocessor, nanotechnology controlled or similarly assisted, that when activated is programmed to recognize an unauthorized attempt to access, reverse engineer any software component, or similar means that is a part of the Fire Suppression Delivery System.

As used herein, to reverse engineer or attempt to reverse engineer any software component or similar means that is a part of the Fire Suppression Delivery System means shall mean to include, but not limited to any unauthorized effort or action to reverse engineer, modify, corrupt, interfere with, decompile, tamper with or otherwise to enter, copy, download, upload to, insert, analyze, deconstruct, remove or otherwise to determine the data, encrypted data, non-encrypted data, code, codes, code sequences, source code, operating codes, operating sequence(s), operating code sequence(s), operating means, software operating means, program, program sequence, programming sequence, operating program, operating program sequence of any software component, or similar means of any component, that is a part of the Fire Suppression Delivery System.

As also used herein, the Fire Suppression Delivery System's Software Security means shall be a means comprising a method, software program provision, conveyance, technique or similar means that when activated to prevent an unauthorized attempt to reverse engineer or otherwise access the Fire Suppression Delivery System, will activate the software/program means to prevent same.

In an embodiment, FIG. 8 illustrates a block diagram where the Hybrid Smart Fire Extinguishment Encasement's onboard software security means detects an unauthorized attempt to access the software systems therein. Here, such detection activates the activatable software program to prevent such access, and where access prevention is successful, normal operations of the encasement continues. At the same time an alert is transmitted by its transceiver to a remote; independent monitoring means of the Fire Suppression Delivery System, indicating at least the time, date and location of the encasement at the time of the attempt. If, however, access prevention is unsuccessful, the activatable means activates the program that will convert the software code of other programs and data of the encasement to a positive or negative binary code, but not both, and transmit the same alarm. The transceiver will also serve as a transponder to emit a traceable signal, to permit authorized users the ability to physically locate the affected Hybrid Smart Fire Extinguishment Encasement.

In an embodiment, FIG. 8 also illustrates in a block diagram the presence of an independent, second or optional onboard software security monitoring means. Here, where the independent software security monitoring means detects an unauthorized access of the software systems therein, and a failure of the first or primary onboard monitoring means to detect same, its activatable means activates the program that will convert the software code of other programs and data of the encasement to a positive or negative binary code, but not both, and transmit an alarm to a remote, independent monitoring means of the Fire Suppression Delivery System, indicating at least the time, date and location of the encasement at the time of the attempt. The transceiver will also serve as a transponder to emit a traceable signal, to permit authorized users the ability to physically locate the affected Hybrid Smart Fire Extinguishment Encasement.

As also used herein, the Fire Suppression Delivery System's Software Security means shall be a means comprising a method, software program provision, conveyance, technique or similar means that when activated to prevent an unauthorized attempt to reverse engineer or otherwise access the Fire Suppression Delivery System, will rapidly cause the insertion, uploading of a means, conveyance, method, mechanism, software code or program, or similar method that will result in destroying, rendering inoperable, and eliminating all data from the electronic means used to intrude upon the affected Fire Suppression Delivery System's programming, software, software controlled systems or components.

As also used herein, the Fire Suppression Delivery System's Software Security means shall be a means comprising a method, software program provision, conveyance, technique or similar means that when activated to prevent an unauthorized attempt to reverse engineer or otherwise access the Fire Suppression Delivery System, will rapidly cause in an irretrievable, irreversible, permanent, thorough, complete manner or as similarly known by those skilled in the art of computer programming, computer program development, the destruction of, self-destruction of, inability to access, operate, run, download, copy, reproduce, reverse engineer the Fire Suppression Delivery System's software source code.

As also used herein, the Fire Suppression Delivery System's Software Security means shall be a means comprising a method, software program provision, conveyance, technique or similar means that when activated to prevent an unauthorized attempt to reverse engineer or otherwise access software and software related components of the Fire Suppression Delivery System, will convert the software program used for the unauthorized access and render same inoperable and eliminate all data from the electronic means used to intrude upon the Fire Suppression Delivery System's software and software related components, encrypted and unencrypted data, memory, to the same single negative or positive binary code, to prevent access, reverse engineer, analysis, copying, decompiling, uploading to, downloading of the anti-intruder sequence, code, program, or means.

In an embodiment, FIG. 8 further illustrates in a block diagram an optional inclusion to the Hybrid Smart Fire Extinguishment Encasement's onboard software security means, where a program, code, sequence or similar means that will prevent the intended function of the unauthorized means' software, software source code, and its operating system. Once uploaded to same, activation of an activatable means will then convert the binary codes of this software program to a positive or negative binary code, but not both, so as to prevent reverse engineering of the software program that rendered inoperable the intruding system.

In an embodiment, FIG. 9 illustrates a structure (900) where the primary fire (target) area (904) is accessible to firefighters. There is a substructure (905) within the (primary) structure (900) where a fire exists within same but where an open access way is not available to firefighters or to smart fire extinguishment encasements. Data generated by the structural and fire scanning means of the encasement's launching means to produce a two-dimensional and/or a three-dimensional map of the structure and the fire's thermal topography will show the structural layout, including that of the substructure, the fire within the primary structure area and the substructure, as well as the position of the fire relative to the substructure's containment wall(s). This data will be incorporated into the encasement's navigation, trajectory and discharge program. When a Hybrid Smart Fire Extinguishment Encasement (907) is discharged from its launching means and activated its onboard scanning means will actively monitor the structure and fire; compare its scan data to the pre-launch programming data; conform its navigation and trajectory programming accordingly in conjunction with obstruction detection and collision detection and avoidance scan data: so as to navigate through the structure (and substructure) for the purpose of targeting and extinguishing the fire therein.

Where its scan data indicates that a breach in the substructure containment wall has not occurred, or is insufficient for unobstructed passage of the encasement to the interior region of the substructure, the encasement can either hover in position or attach itself to a surface structure and wait. Along with activation of the activatable means to magnetize its magnetic surface to facilitate attachment of the encasement to a metallic surface within the (primary) structure, then the encasement can continue to scan the structure and substructure, then detach and enter the substructure where scanning indicates sufficient clearance to enter same has occurred. The electronic beacon or transceiver will provide a means to monitor its position within the structure.

Where collision detection and avoidance scanning indicates the position or approach of an obstruction or debris relative to the encasement's position, the Hybrid Smart Fire Extinguishment Encasement can disengage from its hold position by demagnetizing its magnetic surface and activating its propulsion means, reposition itself at a different location in the structure (or, where necessary, discharge to a secondary fire target or exit the structure) until access to the target area is feasible.

### REFERENCES

| | | |
|---|---|---|
| 5,774,091 | McEwan; Thomas E. | Jun. 30, 1998 |
| 5,781,146 | Frederick; Philip R. | Jul. 14, 1998 |
| 5,805,110 | McEwan; Thomas E. | Sep. 8, 1998 |
| 6,055,042 | Sarangapani; Jagannathan | Apr. 25, 2000 |
| 6,056,237 | Woodland; Richard L. K. | May 2, 2000 |
| 6,089,324 | Mahrt; David M. | Jul. 18, 2000 |
| 6,100,839 | Heger, et al. | Aug. 8, 2000 |
| 6,109,359 | Ballard; Paul Corwin | Aug. 29, 2000 |
| 6,138,547 | Larsson, et al. | Oct. 31, 2000 |
| 6,276,459 | Herrick, et al. | Aug. 21, 2001 |
| 6,307,514 | West; James B. | Oct. 23, 2001 |
| 6,328,225 | Crampton; George | Dec. 11, 2001 |
| 6,402,087 | Farina, et al. | Jun. 11, 2002 |
| 6,466,155 | Taylor, et al. | Oct. 15, 2002 |
| 6,619,029 | Solberg, et al. | Sep. 16, 2003 |
| 6,665,063 | Jamieson, et al. | Dec. 16, 2003 |
| 6,723,975 | Saccomanno; Robert J. | Apr. 20, 2004 |
| 6,724,341 | Pereira, et al. | Apr. 20, 2004 |
| 6,727,841 | Mitra; Atindra | Apr. 27, 2004 |
| 6,747,576 | Schaefer; Christoph | Jun. 8, 2004 |
| 6,789,764 | Bass, et al. | Sep. 14, 2004 |
| 6,840,480 | Carroll; Ernest A. | Jan. 11, 2005 |
| 6,864,826 | Stove; George Colin | Mar. 8, 2005 |
| 6,867,727 | Mitra; Atindra | Mar. 15, 2005 |
| 6,871,439 | Edwards; Oliver J. | Mar. 29, 2005 |
| 6,885,334 | Hager, et al. | Apr. 26, 2005 |
| 6,892,644 | Rastegar, et al. | May 17, 2005 |
| 6,903,676 | Frady, et al. | Jun. 7, 2005 |
| 6,918,244 | Dickau; John Eugene | Jul. 19, 2005 |
| 6,922,059 | Zank, et al. | Jul. 26, 2005 |
| 6,975,246 | Trudeau; Tim K. | Dec. 13, 2005 |
| 6,976,653 | Perlo, et al. | Dec. 20, 2005 |
| 6,981,672 | Clancy, et al. | Jan. 3, 2006 |
| 6,981,844 | Perkinson, et al. | Jan. 3, 2006 |
| 7,026,931 | Tsuji; Masatoshi | Apr. 11, 2006 |
| 20050139363 | Thomas, Michael S. | Jul. 29, 2004 |
| 11\349,785 | Thomas, Michael S. | Feb. 7, 2006 |

1-8. (canceled)

9. A fire extinguishing system that comprises:
a. a launchable fire extinguishing system comprising:
1. a fire extinguishment encasement adapted for containing fire extinguishing material;
2. a quantity of fire extinguishing material; and
3. a system to forcibly expel fire extinguishing material from the fire extinguishment encasement upon command to a targeted fire area;
wherein when the fire extinguishment encasement is activated and launched it will seek the targeted fire area and deliver the fire extinguishing material to the targeted fire area, and the activated propeller will correct the targeting of the fire extinguishing encasement.

10. A system of claim 9 that comprises:
a. a miniaturized propulsion system;
b. deployable, independently maneuverable canards;
c. an exhaust ducting system; and
d. a system to divert a portion of exhaust to the exhaust ducting system.

11. A system of claim 10 that comprises:
a. an obstruction detection subsystem;
b. a collision detection and avoidance subsystem;
c. an object recognition scanning system;
d. a database of objects common to marine and landbased structures;
e. structural scanning systems;
f. thermal scanning systems; and
g. a situation awareness system.

12. A system of claim 9 that comprises a surface that can be magnetized on command and demagnetized on command for attachment of the encasement to a metal surface,

13. A system of claim 9 that comprises a security system to prevent unauthorized operation of the system.
